(19) United States
(12) Patent Application Publication
(10) Pub. No.: US 2026/0171035 A1
(43) Pub. Date: Jun. 18, 2026

(54) DISPLAY APPARATUS, METHOD OF DRIVING THE SAME AND ELECTRONIC APPARATUS INCLUDING THE SAME

(71) Applicant: Samsung Display Co., LTD., Yongin-si (KR)

(72) Inventors: SANG YONG NO, Yongin-si (KR); Kyeongmin PARK, Yongin-si (KR)

(21) Appl. No.: 19/411,894

(22) Filed: Dec. 8, 2025

(30) Foreign Application Priority Data
Dec. 18, 2024 (KR) 10-2024-0189648

(51) Int. Cl. G09G 3/3291; G06F 3/01

(52) U.S. Cl. CPC G09G 3/3291; G06F 3/013; G09G 2300/0828; G09G 2310/0286; G09G 2310/0294; G09G 2310/0297; G09G 2330/021

(57) ABSTRACT

A display apparatus includes a display panel, a data driver, a driving controller and an eye tracker. The data driver is configured to output a data voltage to the display panel. The driving controller is configured to control an operation of the data driver. The eye tracker is configured to output a view signal representing a user's viewing position to the driving controller. The data driver includes a plurality of interface circuits configured to independently operate and a plurality of drivers configured to independently operate, the drivers being connected one-to-one to the interface circuits. The display panel includes a plurality of display areas corresponding one-to-one to the drivers. A resolution of a display area corresponding to the user's viewing position is different from a resolution of a display area not corresponding to the user's viewing position.

This application claims priority to Korean Patent Application No. 10-2024-0189648,

filed on Dec. 18, 2024, and all the benefits accruing therefrom under 35 U.S.C. § 119, the content of which in its entirety is herein incorporated by reference.

### BACKGROUND

### 1. Field

Embodiments of the present disclosure relate to a display apparatus, a method of driving the display apparatus and an electronic apparatus including the display apparatus. More particularly, embodiments of the present disclosure relate to a display apparatus reducing a power consumption, a method of driving the display apparatus and an electronic apparatus including the display apparatus.

### 2. Description of the Related Art

Generally, a display apparatus includes a display panel and a display panel driver. The display panel includes a plurality of gate lines, a plurality of data lines, a plurality of emission lines and a plurality of pixels. The display panel driver includes a gate driver, a data driver, an emission driver and a driving controller. The gate driver outputs gate signals to the gate lines. The data driver outputs data voltages to the data lines. The emission driver outputs emission signals to the emission lines. The driving controller controls the gate driver, the data driver and the emission driver.

A human eye may perceive a central visual area as clear and a peripheral visual area as blurry. Thus, a user may not be able to perceive a difference in image quality even if a resolution of the peripheral visual area decreases.

Therefore, if an entire area of the display panel displays an image at the same resolution regardless of the user's viewing position, a computational load and a power consumption of the display apparatus may be wasted.

### SUMMARY

Embodiments of the present disclosure provide a display apparatus determining a user's viewing position, increasing a resolution of a display area corresponding to the viewing position and decreasing a resolution of a display area far from the viewing position to reduce a computational load and a power consumption of the display apparatus.

Embodiments of the present disclosure provide a method of driving the display apparatus.

Embodiments of the present disclosure provide an electronic apparatus including the display apparatus.

In an embodiment of a display apparatus according to the present disclosure, the display apparatus includes a display panel, a data driver, a driving controller and an eye tracker. The data driver is in signal communication with the display panel and is configured to output a data voltage to the display panel. The driving controller is in signal communication with the data driver and is configured to control an operation of the data driver. The eye tracker is in signal communication with the driving controller and is configured to output a view signal representing a user's viewing position to the driving controller. The data driver includes a plurality of interface circuits configured to independently operate and a plurality of drivers configured to independently operate, the drivers being connected one-to-one to the interface circuits. The display panel includes a plurality of display areas corresponding one-to-one to the drivers. A resolution of a display area corresponding to the user's viewing position is different from a resolution of a display area not corresponding to the user's viewing position.

In an embodiment, as a distance between the display area and the user's viewing position increases, the resolution of the display may decrease.

In an embodiment, the interface circuit may be configured to receive a data signal corresponding to the interface circuit and a resolution signal corresponding to the interface circuit.

In an embodiment, the driver may include a shift register configured to receive a horizontal synchronization signal and a clock signal, a sampling latch connected to the shift register and configured to receive the data signal, a demultiplexer (demux) connected to the sampling latch and configured to receive the resolution signal, a holding latch connected to the sampling latch through the demux, a digital to analog converter connected to the holding latch and an amplifier connected to the digital to analog converter.

In an embodiment, when a resolution of a first display area is a full resolution, a first sampling latch of a first driver is configured to store a first pixel data signal, a second sampling latch of the first driver is configured to store a second pixel data signal, a third sampling latch of the first driver is configured to store a third pixel data signal, a fourth sampling latch of the first driver is configured to store a fourth pixel data signal, a fifth sampling latch of the first driver is configured to store a fifth pixel data signal, a sixth sampling latch of the first driver is configured to store a sixth pixel data signal, a seventh sampling latch of the first driver is configured to store a seventh pixel data signal, an eighth sampling latch of the first driver is configured to store an eighth pixel data signal, a first holding latch of the first driver connected to the first sampling latch is configured to store the first pixel data signal, a second holding latch of the first driver connected to the second sampling latch is configured to store the second pixel data signal, a third holding latch of the first driver connected to the third sampling latch is configured to store the third pixel data signal, a fourth holding latch of the first driver connected to the fourth sampling latch is configured to store the fourth pixel data signal, a fifth holding latch of the first driver connected to the fifth sampling latch is configured to store the fifth pixel data signal, a sixth holding latch of the first driver connected to the sixth sampling latch is configured to store the sixth pixel data signal, a seventh holding latch of the first driver connected to the seventh sampling latch is configured to store the seventh pixel data signal and an eighth holding latch of the first driver connected to the eighth sampling latch is configured to store the eighth pixel data signal.

In an embodiment, when the resolution of the first display area is the full resolution, a demux of the first driver may connect the first sampling latch to the first holding latch, may connect the second sampling latch to the second holding latch, may connect the third sampling latch to the third holding latch, may connect the fourth sampling latch to the fourth holding latch, may connect the fifth sampling latch to the fifth holding latch, may connect the sixth sampling latch to the sixth holding latch, may connect the seventh sampling latch to the seventh holding latch and may connect the eighth sampling latch to the eighth holding latch in response to a first resolution signal.

In an embodiment, when a resolution of a first display area is a half resolution, a first sampling latch of a first driver is configured to store a first pixel data signal, a third sampling latch of the first driver is configured to store a third pixel data signal, a fifth sampling latch of the first driver is configured to store a fifth pixel data signal, a seventh sampling latch of the first driver is configured to store a seventh pixel data signal, a first holding latch of the first driver connected to the first sampling latch is configured to store the first pixel data signal, a second holding latch of the first driver connected to the first sampling latch is configured to store the first pixel data signal, a third holding latch of the first driver connected to the third sampling latch is configured to store the third pixel data signal, a fourth holding latch of the first driver connected to the third sampling latch is configured to store the third pixel data signal, a fifth holding latch of the first driver connected to the fifth sampling latch is configured to store the fifth pixel data signal, a sixth holding latch of the first driver connected to the fifth sampling latch is configured to store the fifth pixel data signal, a seventh holding latch of the first driver connected to the seventh sampling latch is configured to store the seventh pixel data signal and an eighth holding latch of the first driver connected to the seventh sampling latch is configured to store the seventh pixel data signal.

In an embodiment, when the resolution of the first display area is the half resolution, a demux of the first driver may connect the first sampling latch to the first holding latch and the second holding latch, may connect the third sampling latch to the third holding latch and the fourth holding latch, may connect the fifth sampling latch to the fifth holding latch and the sixth holding latch and may connect the seventh sampling latch to the seventh holding latch and the eighth holding latch in response to a first resolution signal.

In an embodiment, when the resolution of the first display area is the half resolution, a second sampling latch, a fourth sampling latch, a sixth sampling latch and an eighth sampling latch may be configured not to store a pixel data signal.

In an embodiment, when a resolution of a first display area is a quarter resolution, a first sampling latch of a first driver is configured to store a first pixel data signal, a fifth sampling latch of the first driver is configured to store a fifth pixel data signal, a first holding latch of the first driver connected to the first sampling latch is configured to store the first pixel data signal, a second holding latch of the first driver connected to the first sampling latch is configured to store the first pixel data signal, a third holding latch of the first driver connected to the first sampling latch is configured to store the first pixel data signal, a fourth holding latch of the first driver connected to the first sampling latch is configured to store the first pixel data signal, a fifth holding latch of the first driver connected to the fifth sampling latch is configured to store the fifth pixel data signal, a sixth holding latch of the first driver connected to the fifth sampling latch is configured to store the fifth pixel data signal, a seventh holding latch of the first driver connected to the fifth sampling latch is configured to store the fifth pixel data signal and an eighth holding latch of the first driver connected to the fifth sampling latch is configured to store the fifth pixel data signal.

In an embodiment, when the resolution of the first display area is the quarter resolution, a demux of the first driver may connect the first sampling latch to the first holding latch, the second holding latch, the third holding latch and the fourth holding latch and may connect the fifth sampling latch to the fifth holding latch, the sixth holding latch, the seventh holding latch and the eighth holding latch in response to a first resolution signal.

In an embodiment, when the resolution of the first display area is the quarter resolution, a second sampling latch, a third sampling latch, a fourth sampling latch, a sixth sampling latch, a seventh sampling latch and an eighth sampling latch may be configured not to store a pixel data signal.

In an embodiment, when a resolution of a first display area is a full resolution, corresponding pixel data signals may be stored to a first sampling latch, a fifth sampling latch, a ninth sampling latch and a thirteenth sampling latch of a first driver at a rising edge of a first clock signal, corresponding pixel data signals may be stored to a second sampling latch, a sixth sampling latch, a tenth sampling latch and a fourteenth sampling latch of the first driver at a rising edge of a second clock signal, corresponding pixel data signals may be stored to a third sampling latch, a seventh sampling latch, an eleventh sampling latch and a fifteenth sampling latch of the first driver at a rising edge of a third clock signal and corresponding pixel data signals may be stored to a fourth sampling latch, an eighth sampling latch, a twelfth sampling latch and a sixteenth sampling latch of the first driver at a rising edge of a fourth clock signal.

In an embodiment, when a resolution of a first display area is a half resolution, corresponding pixel data signals may be stored to a first sampling latch, a fifth sampling latch, a ninth sampling latch and a thirteenth sampling latch of a first driver at a rising edge of a first clock signal, corresponding pixel data signals may be stored to a third sampling latch, a seventh sampling latch, an eleventh sampling latch and a fifteenth sampling latch of the first driver at a rising edge of a third clock signal and a second clock signal and a fourth clock signal may not have active pulses.

In an embodiment, when a resolution of a first display area is a quarter resolution, corresponding pixel data signals may be stored to a first sampling latch, a fifth sampling latch, a ninth sampling latch and a thirteenth sampling latch of a first driver at a rising edge of a first clock signal and a second clock signal, a third clock signal and a fourth clock signal may not have active pulses.

In an embodiment, the display areas may be disposed adjacent to each other in a first direction. The display area corresponding to the user's viewing position may have two or more resolutions in a second direction.

In an embodiment, as a distance between a display position and the user's viewing position increases in the display area corresponding to the user's viewing position, a resolution of the display position may decrease.

In an embodiment of a method of driving a display apparatus according to the present disclosure, the method includes determining a user's viewing position and driving a display area corresponding to the user's viewing position at a first resolution and driving a display area not corresponding to the user's viewing position at a second resolution different from the first resolution, wherein driving the display area corresponding to the user's viewing position and the display area not corresponding to the user's viewing position includes using a plurality of interface circuits configured to independently operate and a plurality of drivers configured to independently operate, and wherein the drivers being connected one-to-one to the interface circuits.

In an embodiment of an electronic apparatus according to the present disclosure, the electronic apparatus includes a display panel, a data driver, a driving controller, an eye tracker and a processor. The data driver is in signal communication with the display panel and is configured to output a data voltage to the display panel. The driving controller is in signal communication with the data driver and is configured to control an operation of the data driver. The eye tracker is in signal communication with the driving controller and is configured to output a view signal representing a user's viewing position to the driving controller. The processor is in signal communication with the driving controller and is configured to output input image data and an input control signal to the driving controller. The data driver includes a plurality of interface circuits configured to independently operate and a plurality of drivers configured to independently operate, the drivers being connected one-to-one to the interface circuits. The display panel includes a plurality of display areas corresponding one-to-one to the drivers. A resolution of a display area corresponding to the user's viewing position is different from a resolution of a display area not corresponding to the user's viewing position.

According to the display apparatus and the method of driving the display apparatus and the electronic apparatus including the display apparatus, the data driver may include the interface circuits which independently operate and the drivers which independently operate and are connected to the interface circuits respectively and the display panel may include the display areas corresponding to the drivers, respectively.

The resolution of the display area corresponding to the user's viewing position may be set to be high and the resolution of the display area far from the user's viewing position may be set to be low so that a computational load and a power consumption of the display apparatus may be reduced without deteriorating a display quality.

### BRIEF DESCRIPTION OF THE DRAWINGS

The above and other features and advantages of the present disclosure will become more apparent by describing in detailed embodiments thereof with reference to the accompanying drawings, in which:

FIG. 1 is a block diagram illustrating a display apparatus according to an embodiment of the present disclosure;

FIG. 2 is a diagram illustrating a display panel and a data driver of FIG. 1;

FIG. 3 is a block diagram illustrating a first driver of FIG. 2;

FIG. 4A is a diagram illustrating a sampling latch, a demux and a holding latch of the first driver of FIG. 3 when a resolution of a first display area of FIG. 1 is a full resolution;

FIG. 4B is a diagram illustrating the sampling latch, the demux and the holding latch of the first driver of FIG. 3 when the resolution of the first display area of FIG. 1 is a half resolution;

FIG. 4C is a diagram illustrating the sampling latch, the demux and the holding latch of the first driver of FIG. 3 when the resolution of the first display area of FIG. 1 is a quarter resolution;

FIG. 5 is a timing diagram illustrating a clock signal of a data driver according to a non-limiting embodiment;

FIG. 6 is a timing diagram illustrating a data signal of a data driver according to the non-limiting embodiment;

FIG. 7 is a timing diagram illustrating a clock signal of the first driver of FIG. 3 when the resolution of the first display area of FIG. 1 is the full resolution;

FIG. 8 is a diagram illustrating a method of transmitting a data signal of the first driver of FIG. 3 to the sampling latch when the resolution of the first display area of FIG. 1 is the full resolution;

FIG. 9 is a timing diagram illustrating a clock signal of the first driver of FIG. 3 when the resolution of the first display area of FIG. 1 is the half resolution;

FIG. 10 is a diagram illustrating a method of transmitting a data signal of the first driver of FIG. 3 to the sampling latch when the resolution of the first display area of FIG. 1 is the half resolution;

FIG. 11 is a timing diagram illustrating a clock signal of the first driver of FIG. 3 when the resolution of the first display area of FIG. 1 is the quarter resolution;

FIG. 12 is a diagram illustrating a method of transmitting a data signal of the first driver of FIG. 3 to the sampling latch when the resolution of the first display area of FIG. 1 is the quarter resolution;

FIG. 13 is a diagram illustrating a display panel and a data driver according to an embodiment of the present disclosure;

FIG. 14 is a block diagram illustrating an electronic apparatus according to an embodiment of the present disclosure;

FIG. 15 is a diagram illustrating an example in which the electronic apparatus of FIG. 14 is implemented as a virtual reality display system;

FIG. 16 is a diagram illustrating an example in which the electronic apparatus of FIG. 14 is implemented as a smart phone; and

FIG. 17 is a block diagram illustrating an electronic apparatus according to an embodiment of the present disclosure.

### DETAILED DESCRIPTION

Hereinafter, the present disclosure will be explained in detail with reference to the accompanying drawings.

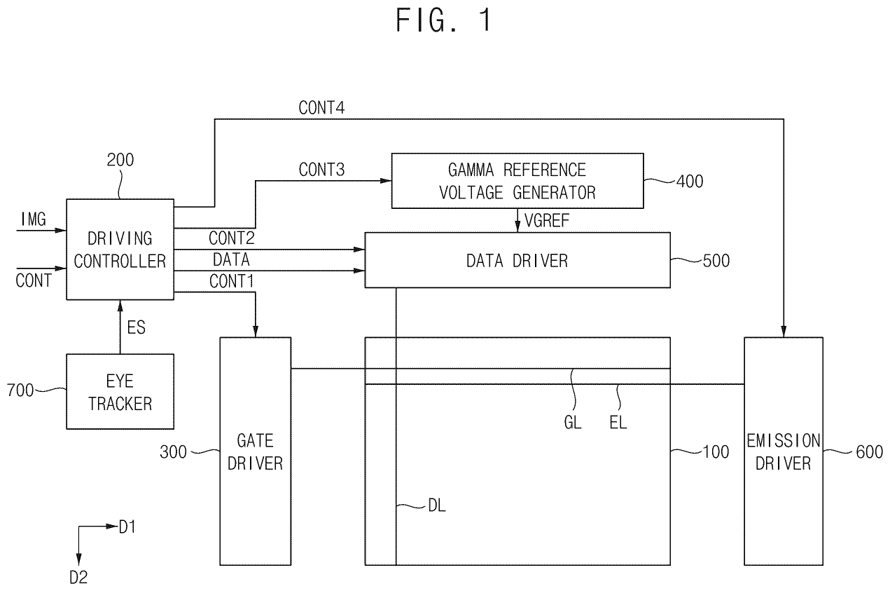

FIG. 1 is a block diagram illustrating a display apparatus according to an embodiment of the present disclosure.

Embodiments supported by the present disclosure will now be described more fully hereinafter with reference to the accompanying drawings, in which one or more example embodiments are illustrated. Aspects supported by the present disclosure may, however, be embodied in different forms and should not be construed as limited to the embodiments set forth herein. Rather, these example embodiments are provided so that this disclosure will be thorough and complete, and will fully convey the scope of example aspects of embodiments of the present disclosure to those skilled in the art.

Terms such as, for example, first, second, and the like may be used to describe various components, but the components should not be limited by the terms. The terms as used herein may distinguish one component from other components and are not to be limited by the terms. For example, without departing the scope of the present disclosure, a first component may be referred to as a second component, and similarly, the second component may also be referred to as the first component. The terms of a singular form may include plural forms unless otherwise specified.

The terminology used herein is for the purpose of describing particular embodiments and is not intended to be limiting. As used herein, “a,” “an,” “the,” and “at least one” do not denote a limitation of quantity, and are intended to include both the singular and plural, unless the context clearly indicates otherwise. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, comp

The terms “about” or “approximately” as used herein are inclusive of the stated value and include a suitable range of deviation for the particular value as determined by one of ordinary skill in the art, considering the measurement in question and the error associated with measurement of the particular quantity. The term “about” can mean within one or more standard deviations, or within ±30%, 20%, 10%, 5% of the stated value, for example.

The term “substantially,” as used herein, means approximately or actually. The term “substantially equal” means approximately or actually equal. The term “substantially the same” means approximately or actually the same. The term “substantially identical” means approximately or actually identical. The term “substantially perpendicular” means approximately or actually perpendicular.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

Embodiments are described herein with reference to cross section illustrations that are schematic illustrations of example embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases.

It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

Referring to FIG. 1, the display apparatus includes a display panel 100 and a display panel driver. The display panel driver includes a driving controller 200, a gate driver 300, a gamma reference voltage generator 400, a data driver 500 and an emission driver 600. The display panel driver further includes an eye tracker 700.

The display panel 100 has a display region on which an image is displayed and a peripheral region adjacent to the display region.

The display panel 100 includes a plurality of gate lines GL, a plurality of data lines DL, a plurality of emission lines EL and a plurality of pixels electrically connected to the gate lines GL, the data lines DL and the emission lines EL. The gate lines GL may extend in a first direction D1, the data lines DL may extend in a second direction D2 crossing the first direction D1 and the emission lines EL may extend in the first direction D1.

Each pixel of the display panel 100 includes a light emitting element. For example, the light emitting element may be a micro organic light emitting diode (Micro-OLED).

For example, the display apparatus according to the present embodiment may be a micro display apparatus including the micro organic light emitting diode (Micro-OLED). For example, the pixel may be formed on a silicon substrate. For example, the display apparatus may be the micro display apparatus including the pixels formed on the silicon substrate.

The driving controller 200 receives input image data IMG and an input control signal CONT from an external apparatus. In a non-limiting embodiment, the input image data IMG includes color data associated with one or more pixels. For example, the input image data IMG may include red image data, green image data and blue image data. The input image data IMG may include white image data. The input image data IMG may include magenta image data, cyan image data and yellow image data. The input control signal CONT may include a master clock signal and a data enable signal. The input control signal CONT may further include a vertical synchronizing signal and a horizontal synchronizing signal.

The driving controller 200 generates a first control signal CONT1, a second control signal CONT2, a third control signal CONT3, a fourth control signal CONT4 and a data signal DATA based on the input image data IMG and the input control signal CONT.

The driving controller 200 generates the first control signal CONT1 for controlling an operation of the gate driver 300 based on the input control signal CONT, and outputs the first control signal CONT1 to the gate driver 300. The first control signal CONT1 may include a vertical start signal and a gate clock signal.

The driving controller 200 generates the second control signal CONT2 for controlling an operation of the data driver 500 based on the input control signal CONT, and outputs the second control signal CONT2 to the data driver 500. The second control signal CONT2 may include a horizontal start signal and a load signal.

The driving controller 200 generates the data signal DATA based on the input image data IMG. The driving controller 200 outputs the data signal DATA to the data driver 500.

The driving controller 200 generates the third control signal CONT3 for controlling an operation of the gamma reference voltage generator 400 based on the input control signal CONT, and outputs the third control signal CONT3 to the gamma reference voltage generator 400.

The driving controller 200 generates the fourth control signal CONT4 for controlling an operation of the emission driver 600 based on the input control signal CONT, and outputs the fourth control signal CONT4 to the emission driver 600.

The gate driver 300 generates gate signals driving the gate lines GL in response to the first control signal CONT1 received from the driving controller 200. The gate driver 300 may output the gate signals to the gate lines GL.

The gamma reference voltage generator 400 generates a gamma reference voltage VGREF in response to the third control signal CONT3 received from the driving controller 200. The gamma reference voltage generator 400 provides the gamma reference voltage VGREF to the data driver 500. The gamma reference voltage VGREF has a value corresponding to a level of the data signal DATA.

In an embodiment, the gamma reference voltage generator 400 may be disposed in the driving controller 200, or in the data driver 500.

The data driver 500 receives the second control signal CONT2 and the data signal DATA from the driving controller 200, and receives the gamma reference voltages VGREF from the gamma reference voltage generator 400. The data driver 500 converts the data signal DATA into data voltages having an analog type using the gamma reference voltages VGREF. The data driver 500 outputs the data voltages to the data lines DL.

The emission driver 600 generates emission signals to drive the emission lines EL in response to the fourth control signal CONT4 received from the driving controller 200. The emission driver 600 may output the emission signals to the emission lines EL.

Although the gate driver 300 is disposed at a first side of the display panel 100 and the emission driver 600 is disposed at a second side of the display panel 100 opposite to the first side in FIG. 1 for convenience of explanation, the present disclosure may not be limited thereto. For example, both of the gate driver 300 and the emission driver 600 may be disposed at the first side of the display panel 100. For example, both of the gate driver 300 and the emission driver 600 may be disposed at both sides (e.g. the first side and the second side) of the display panel 100. For example, the gate driver 300 and the emission driver 600 may be integrally formed.

The eye tracker 700 may generate a view signal ES representing a user's viewing position. The eye tracker 700 may output the view signal ES to the driving controller 200.

For example, the eye tracker 700 may track positions of the user's eyeballs. The eye tracker 700 may be disposed in the peripheral region of the display panel 100.

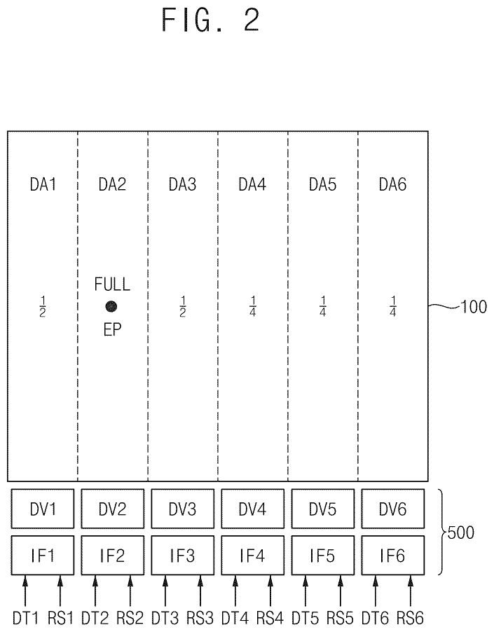

FIG. 2 is a diagram illustrating the display panel 100 and the data driver 500 of FIG. 1.

Referring to FIGS. 1 and 2, the data driver 500 may include interface circuits IF1, IF2, IF3, IF4, IF5 and IF6 which independently operate with respect to one another and drivers DV1, DV2, DV3, DV4, DV5 and DV6 which independently operate with respect to one another and are connected one-to-one to the interface circuits IF1, IF2, IF3, IF4, IF5 and IF6. As described herein, “connected one-to-one” refers to electrical connections where each individual component connects to a single corresponding component. For example, driver DV1 is connected to interface circuit IF1, driver DV2 is connected to interface circuit IF2, driver DV3 is connected to interface circuit IF3, driver DV4 is connected to interface circuit IF4, driver DV5 is connected to interface circuit IF5, and driver DV6 is connected to interface circuit IF6.

In a non-limiting embodiment, the data driver 500 may include a first interface circuit IF1, a second interface circuit IF2 adjacent to the first interface circuit IF1, a third interface circuit IF3 adjacent to the second interface circuit IF2, a fourth interface circuit IF4 adjacent to the third interface circuit IF3, a fifth interface circuit IF5 adjacent to the fourth interface circuit IF4 and a sixth interface circuit IF6 adjacent to the fifth interface circuit IF5.

The first to sixth interface circuits IF1 to IF6 may be disposed adjacent to each other in the first direction D1.

The interface circuits IF1 to IF6 may receive corresponding data signals DT1 to DT6 and corresponding resolution signals RS1 to RS6.

For example, the data driver 500 may include a first driver DV1, a second driver DV2 adjacent to the first driver DV1, a third driver DV3 adjacent to the second driver DV2, a fourth driver DV4 adjacent to the third driver DV3, a fifth driver DV5 adjacent to the fourth driver DV4 and a sixth driver DV6 adjacent to the fifth driver DV5.

The first to sixth drivers DV1 to DV6 may be disposed adjacent to each other in the first direction D1.

The first driver DV1 may be connected to the first interface circuit IF1. The second driver DV2 may be connected to the second interface circuit IF2. The third driver DV3 may be connected to the third interface circuit IF3. The fourth driver DV4 may be connected to the fourth interface circuit IF4. The fifth driver DV5 may be connected to the fifth interface circuit IF5. The sixth driver DV6 may be connected to the sixth interface circuit IF6.

The interface circuits IF1 to IF6 may transmit the data signals DT1 to DT6 and the resolution signals RS1 to RS6 to the corresponding drivers DV1 to DV6.

The display panel 100 includes display areas DA1, DA2, DA3, DA4, DA5 and DA6 which correspond one-to-one to the drivers DV1, DV2, DV3, DV4, DV5 and DV6.

The first to sixth display areas DA1 to DA6 may be disposed adjacent to each other in the first direction D1.

The first driver DV1 may correspond to the first display area DA1. The second driver DV2 may correspond to the second display area DA2. The third driver DV3 may correspond to the third display area DA3. The fourth driver DV4 may correspond to the fourth display area DA4. The fifth driver DV5 may correspond to the fifth display area DA5. The sixth driver DV6 may correspond to the sixth display area DA6.

The first driver DV1 may output a corresponding data voltage to the first display area DA1. The second driver DV2 may output a corresponding data voltage to the second display area DA2. The third driver DV3 may output a corresponding data voltage to the third display area DA3. The fourth driver DV4 may output a corresponding data voltage to the fourth display area DA4. The fifth driver DV5 may output a corresponding data voltage to the fifth display area DA5. The sixth driver DV6 may output a corresponding data voltage to the sixth display area DA6.

Although the data driver 500 includes six interface circuits and six drivers and the display panel 100 includes six display areas in FIG. 2, the present disclosure may not be limited to the number of the interface circuits, the number of the drivers and the number of the display areas. For example, the number of the interface circuits, the number of the drivers and the number of the display areas may be equal to or greater than three. For example, the number of the interface circuits, the number of the drivers and the number of the display areas may be greater than six or less than six.

A resolution of a display area (e.g., the second display area DA2) corresponding to the user's viewing position EP is different from a resolution of a display area (e.g. at least one of the first display area DA1, the third display area DA3, the fourth display area DA4, the fifth display area DA5 and the sixth display area DA6) not corresponding to the user's viewing position EP.

As a distance between the display area and the user's viewing position EP increases, the resolution of the display area may decrease.

For example, in FIG. 2, the second display area DA2 corresponding to the user's viewing position EP may have a full resolution.

For example, in FIG. 2, the first display area DA1 and the third display area DA3 adjacent to the second display area DA2 corresponding to the user's viewing position EP may have a half resolution.

For example, in FIG. 2, the fourth display area DA4, the fifth display area DA5 and the sixth display area DA6 located at a distance of two or more display areas from the second display area DA2 corresponding to the user's viewing position EP may have a quarter resolution.

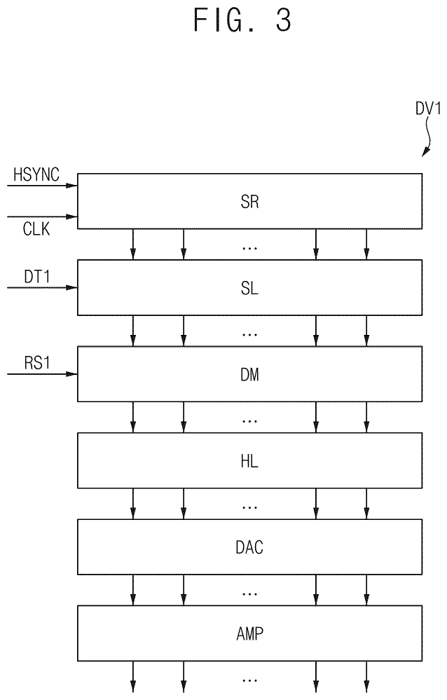

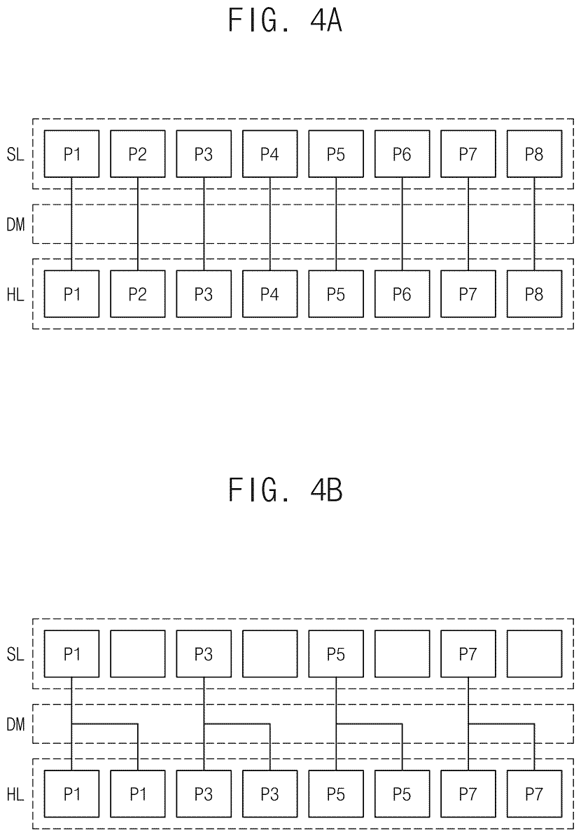

FIG. 3 is a block diagram illustrating the first driver DV1 of FIG. 2. FIG. 4A is a diagram illustrating a sampling latch SL, a demultiplexer (demux) DM and a holding latch HL of the first driver DV1 of FIG. 3 when a resolution of the first display area DA1 of FIG. 1 is a full resolution. FIG. 4B is a diagram illustrating the sampling latch SL, the demux DM and the holding latch HL of the first driver DV1 of FIG. 3 when the resolution of the first display area DA1 of FIG. 1 is a half resolution. FIG. 4C is a diagram illustrating the sampling latch SL, the demux DM and the holding latch HL of the first driver DV1 of FIG. 3 when the resolution of the first display area DA1 of FIG. 1 is a quarter resolution.

A structure and an operation of the first driver DV1 is explained referring to FIGS. 3 to 4C for convenience of explanation. Structures and operations of the second drivers DV2 to the sixth drivers DV6 may be substantially the same as the structure and the operation of the first driver DV1.

Referring to FIGS. 1 to 4C, the first driver DV1 may include a shift register SR receiving a horizontal synchronization signal HSYNC and a clock signal CLK, the sampling latch SL connected to the shift register SR and receiving the data signal DT1, the demux DM connected to the sampling latch SL and receiving the resolution signal RS1, the holding latch HL connected to the sampling latch SL through the demux DM, a digital to analog converter DAC connected to the holding latch HL and an amplifier AMP connected to the digital to analog converter DAC.

The shift register SR, the sampling latch SL, and the holding latch HL may operate a column sequential operation to assign an inputted data signals DT1 to the corresponding data lines DL, respectively.

As shown in FIG. 4A, when the resolution of the first display area DA1 is the full resolution, a first sampling latch of the first driver DV1 may store a first pixel data signal P1, a second sampling latch of the first driver DV1 may store a second pixel data signal P2, a third sampling latch of the first driver DV1 may store a third pixel data signal P3, a fourth sampling latch of the first driver DV1 may store a fourth pixel data signal P4, a fifth sampling latch of the first driver DV1 may store a fifth pixel data signal P5, a sixth sampling latch of the first driver DV1 may store a sixth pixel data signal P6, a seventh sampling latch of the first driver DV1 may store a seventh pixel data signal P7, an eighth sampling latch of the first driver DV1 may store an eighth pixel data signal P8, a first holding latch of the first driver DV1 connected to the first sampling latch may store the first pixel data signal P1, a second holding latch of the first driver DV1 connected to the second sampling latch may store the second pixel data signal P2, a third holding latch of the first driver DV1 connected to the third sampling latch may store the third pixel data signal P3, a fourth holding latch of the first driver DV1 connected to the fourth sampling latch may store the fourth pixel data signal P4, a fifth holding latch of the first driver DV1 connected to the fifth sampling latch may store the fifth pixel data signal P5, a sixth holding latch of the first driver DV1 connected to the sixth sampling latch may store the sixth pixel data signal P6, a seventh holding latch of the first driver DV1 connected to the seventh sampling latch may store the seventh pixel data signal P7 and an eighth holding latch of the first driver DV1 connected to the eighth sampling latch may store the eighth pixel data signal P8.

When the resolution of the first display area DA1 is the full resolution, the demux DM of the first driver DV1 may connect the first sampling latch to the first holding latch, connect the second sampling latch to the second holding latch, connect the third sampling latch to the third holding latch, connect the fourth sampling latch to the fourth holding latch, connect the fifth sampling latch to the fifth holding latch, connect the sixth sampling latch to the sixth holding latch, connect the seventh sampling latch to the seventh holding latch and connect the eighth sampling latch to the eighth holding latch in response to a first resolution signal RS1.

As shown in FIG. 4B, when the resolution of the first display area DA1 is the half resolution, a first sampling latch of the first driver DV1 may store a first pixel data signal P1, a third sampling latch of the first driver DV1 may store a third pixel data signal P3, a fifth sampling latch of the first driver DV1 may store a fifth pixel data signal P5, a seventh sampling latch of the first driver DV1 may store a seventh pixel data signal P7, a first holding latch of the first driver DV1 connected to the first sampling latch may store the first pixel data signal P1, a second holding latch of the first driver DV1 connected to the first sampling latch may store the first pixel data signal P1, a third holding latch of the first driver DV1 connected to the third sampling latch may store the third pixel data signal P3, a fourth holding latch of the first driver DV1 connected to the third sampling latch may store the third pixel data signal P3, a fifth holding latch of the first driver DV1 connected to the fifth sampling latch may store the fifth pixel data signal P5, a sixth holding latch of the first driver DV1 connected to the fifth sampling latch may store the fifth pixel data signal P5, a seventh holding latch of the first driver DV1 connected to the seventh sampling latch may store the seventh pixel data signal P7 and an eighth holding latch of the first driver DV1 connected to the seventh sampling latch may store the seventh pixel data signal P7.

When the resolution of the first display area DA1 is the half resolution, the demux DM of the first driver DV1 may connect the first sampling latch to the first holding latch and the second holding latch, connect the third sampling latch to the third holding latch and the fourth holding latch, connect the fifth sampling latch to the fifth holding latch and the sixth holding latch, connect the seventh sampling latch to the seventh holding latch and the eighth holding latch in response to a first resolution signal RS1.

When the resolution of the first display area DA1 is the half resolution, a second sampling latch, a fourth sampling latch, a sixth sampling latch and an eighth sampling latch of the first driver DV1 may not store the pixel data signal.

As shown in FIG. 4C, when the resolution of the first display area DA1 is the quarter resolution, a first sampling latch of the first driver DV1 may store a first pixel data signal P1, a fifth sampling latch of the first driver DV1 may store a fifth pixel data signal P5, a first holding latch of the first driver DV1 connected to the first sampling latch may store the first pixel data signal P1, a second holding latch of the first driver DV1 connected to the first sampling latch may store the first pixel data signal P1, a third holding latch of the first driver DV1 connected to the first sampling latch may store the first pixel data signal P1, a fourth holding latch of the first driver DV1 connected to the first sampling latch may store the first pixel data signal P1, a fifth holding latch of the first driver DV1 connected to the fifth sampling latch may store the fifth pixel data signal P5, a sixth holding latch of the first driver DV1 connected to the fifth sampling latch may store the fifth pixel data signal P5, a seventh holding latch of the first driver DV1 connected to the fifth sampling latch may store the fifth pixel data signal P5 and an eighth holding latch of the first driver DV1 connected to the fifth sampling latch may store the fifth pixel data signal P5.

When the resolution of the first display area DA1 is the quarter resolution, the demux DM of the first driver DV1 may connect the first sampling latch to the first holding latch, the second holding latch, the third holding latch and the fourth holding latch and connect the fifth sampling latch to the fifth holding latch, the sixth holding latch, the seventh holding latch and the eighth holding latch in response to a first resolution signal RS1.

When the resolution of the first display area DA1 is the quarter resolution, a second sampling latch, a third sampling latch, a fourth sampling latch, a sixth sampling latch, a seventh sampling latch and an eighth sampling latch of the first driver DV1 may not store the pixel data signal.

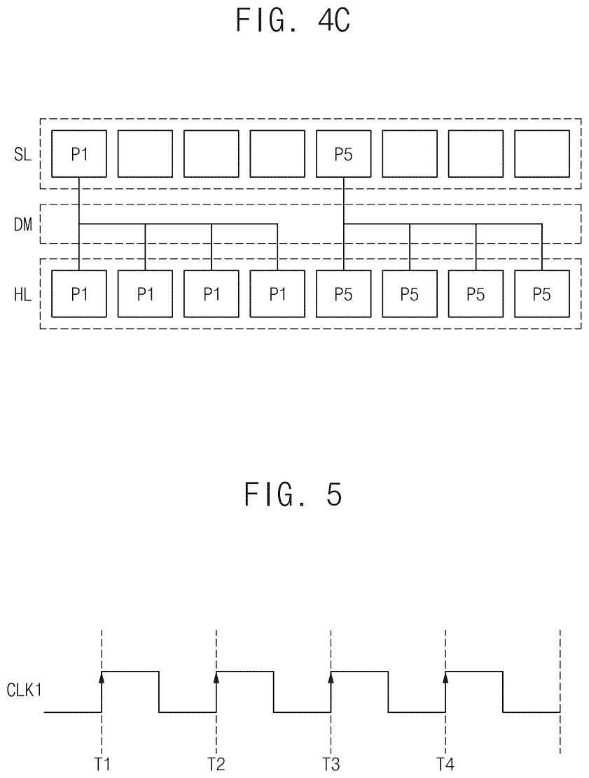

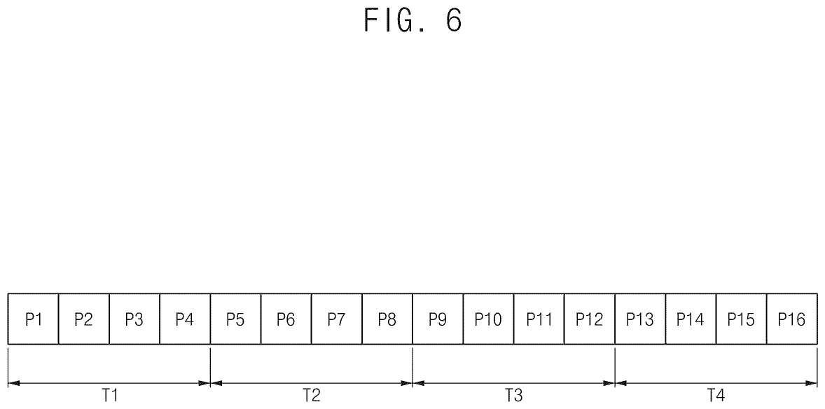

FIG. 5 is a timing diagram illustrating a clock signal of a data driver according to a non-limiting embodiment. FIG. 6 is a timing diagram illustrating a data signal of a data driver according to the non-limiting embodiment.

FIGS. 5 and 6 explain a column sequential operation of the data driver according to the non-limiting embodiment.

Referring to FIGS. 5 and 6, the data driver may operate based on one clock signal CLK1 and pixel data signals of four adjacent pixels may be stored to the sampling latch corresponding to a rising edge of the clock signal CLK1.

For example, first to fourth pixel data signals P1 to P4 may be transmitted to first to fourth sampling latches corresponding to a first rising edge T1 of the clock signal CLK1.

For example, fifth to eighth pixel data signals P5 to P8 may be transmitted to fifth to eighth sampling latches corresponding to a second rising edge T2 of the clock signal CLK1.

For example, ninth to twelfth pixel data signals P9 to P12 may be transmitted to ninth to twelfth sampling latches corresponding to a third rising edge T3 of the clock signal CLK1.

For example, thirteenth to sixteenth pixel data signals P13 to P16 may be transmitted to thirteenth to sixteenth sampling latches corresponding to a fourth rising edge T4 of the clock signal CLK1.

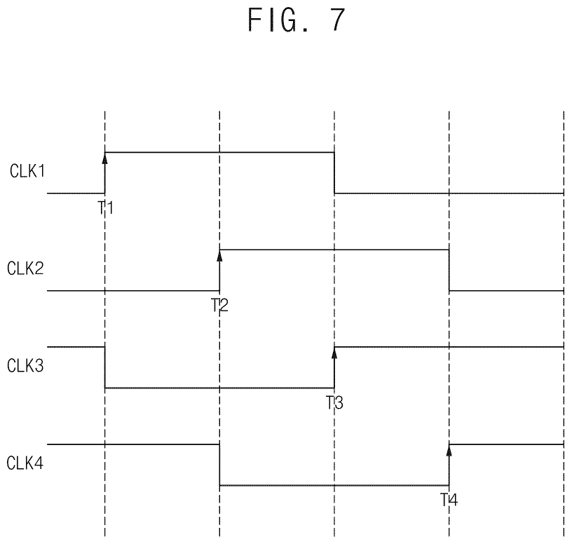

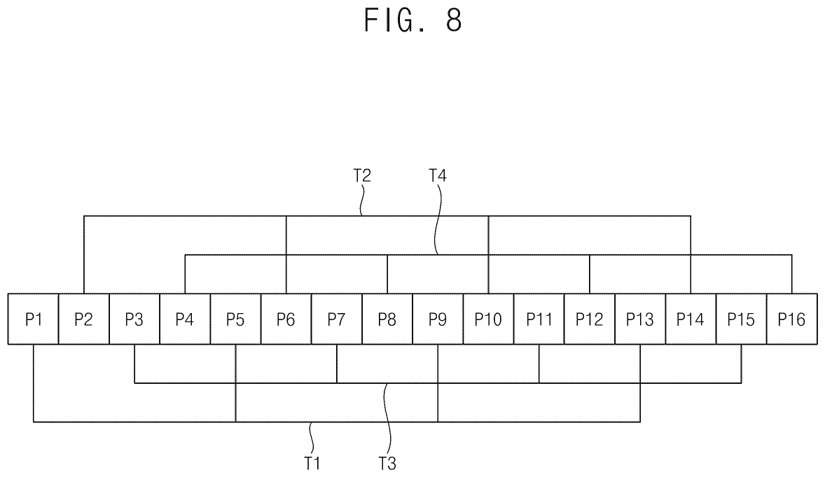

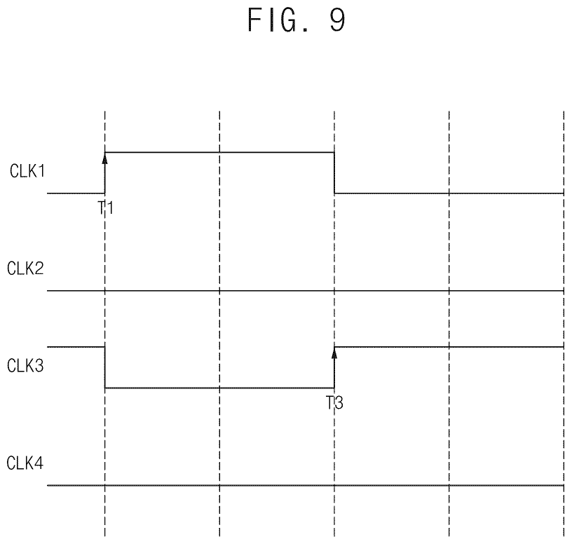

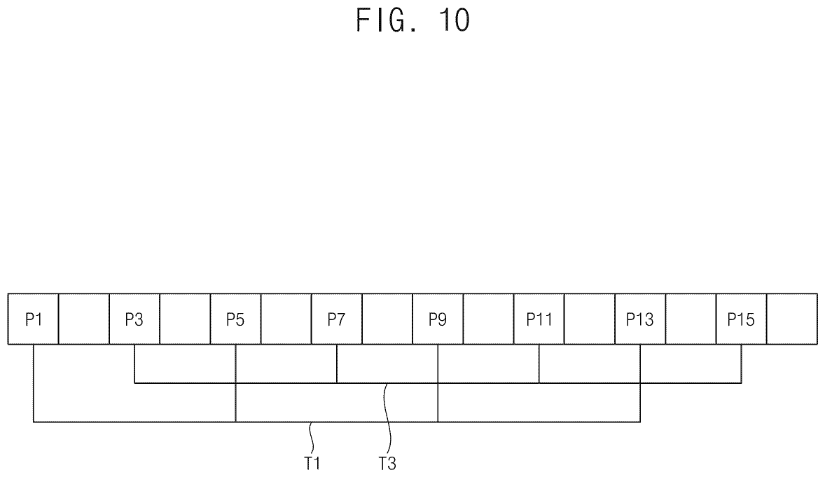

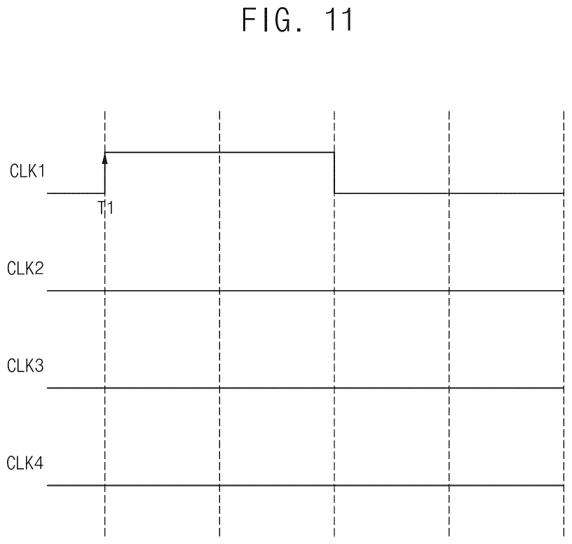

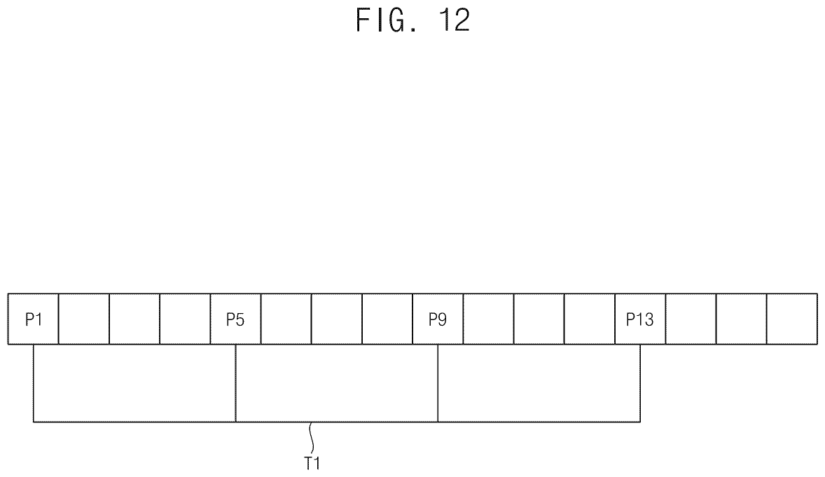

FIG. 7 is a timing diagram illustrating a clock signal CLK1, CLK2, CLK3 and CLK4 of the first driver DV1 of FIG. 3 when the resolution of the first display area DA1 of FIG. 1 is the full resolution. FIG. 8 is a diagram illustrating a method of transmitting a data signal of the first driver DV1 of FIG. 3 to the sampling latch SL when the resolution of the first display area DA1 of FIG. 1 is the full resolution. FIG. 9 is a timing diagram illustrating a clock signal CLK1, CLK2, CLK3 and CLK4 of the first driver DV1 of FIG. 3 when the resolution of the first display area DA1 of FIG. 1 is the half resolution. FIG. 10 is a diagram illustrating a method of transmitting a data signal of the first driver DV1 of FIG. 3 to the sampling latch SL when the resolution of the first display area DA1 of FIG. 1 is the half resolution. FIG. 11 is a timing diagram illustrating a clock signal CLK1, CLK2, CLK3 and CLK4 of the first driver DV1 of FIG. 3 when the resolution of the first display area DA1 of FIG. 1 is the quarter resolution. FIG. 12 is a diagram illustrating a method of transmitting a data signal of the first driver DV1 of FIG. 3 to the sampling latch SL when the resolution of the first display area DA1 of FIG. 1 is the quarter resolution.

FIGS. 7 to 12 explain a column sequential operation of the data driver 500 according to the present embodiment.

A structure and an operation of the first driver DV1 is explained referring to FIGS. 7 to 12 for convenience of explanation. Structures and operations of the second drivers DV2 to the sixth drivers DV6 may be substantially the same as the structure and the operation of the first driver DV1.

Referring to FIG. 7, the data driver may operate based on four clock signals CLK1, CLK2, CLK3 and CLK4, which correspond to pixel data signals P1-P16. For example, pixel data signals P1, P5, P9 and P13 of four spaced-apart pixels may be stored to the sampling latches corresponding to a rising edge T1 of a first clock signal CLK1, pixel data signals P2, P6, P10 and P14 of four spaced-apart pixels may be stored to the sampling latches corresponding to a rising edge T2 of a second clock signal CLK2, pixel data signals P3, P7, P11 and P15 of four spaced-apart pixels may be stored to the sampling latches corresponding to a rising edge T3 of a third clock signal CLK3 and pixel data signals P4, P8, P12 and P16 of four spaced-apart pixels may be stored to the sampling latches corresponding to a rising edge T4 of a fourth clock signal CLK4.

Referring to FIGS. 7 and 8, when the resolution of the first display area DA1 is the full resolution, the corresponding pixel data signals P1, P5, P9 and P13 may be stored to a first sampling latch, a fifth sampling latch, a ninth sampling latch and a thirteenth sampling latch of the first driver DV1 at the rising edge of the first clock signal CLK1, the corresponding pixel data signals P2, P6, P10 and P14 may be stored to a second sampling latch, a sixth sampling latch, a tenth sampling latch and a fourteenth sampling latch of the first driver DV1 at the rising edge of the second clock signal CLK2, the corresponding pixel data signals P3, P7, P11 and P15 may be stored to a third sampling latch, a seventh sampling latch, an eleventh sampling latch and a fifteenth sampling latch of the first driver DV1 at the rising edge of the third clock signal CLK3 and the corresponding pixel data signals P4, P8, P12 and P16 may be stored to a fourth sampling latch, an eighth sampling latch, a twelfth sampling latch and a sixteenth sampling latch of the first driver DV1 at the rising edge of the fourth clock signal CLK4.

Referring to FIGS. 9 and 10, when the resolution of the first display area DA1 is the half resolution, the corresponding pixel data signals P1, P5, P9 and P13 may be stored to the first sampling latch, the fifth sampling latch, the ninth sampling latch and the thirteenth sampling latch of the first driver DV1 at the rising edge of the first clock signal CLK1 and the corresponding pixel data signals P3, P7, P11 and P15 may be stored to the third sampling latch, the seventh sampling latch, the eleventh sampling latch and the fifteenth sampling latch of the first driver DV1 at the rising edge of the third clock signal CLK3.

When the resolution of the first display area DA1 is the half resolution, the second clock signal CLK2 and the fourth clock signal CLK4 may not have active pulses. In FIGS. 9 and 10, the second clock signal CLK2 and the fourth clock signal CLK4 among the first to fourth clock signals CLK1 to CLK4 may not have the active pulses. The first clock signal CLK1 and the third clock signal CLK3 which have active pulses may have a cycle slower than a cycle of the first clock signal CLK1 of FIG. 5. Thus, a computational load and a power consumption of the display apparatus may be reduced.

As explained herein, when the resolution of the first display area DA1 is the half resolution, the pixel data signal P1 stored at the first sampling latch may be stored to the first holding latch and the second holding latch by an operation of the demux DM, the pixel data signal P3 stored at the third sampling latch may be stored to the third holding latch and the fourth holding latch by an operation of the demux DM, the pixel data signal P5 stored at the fifth sampling latch may be stored to the fifth holding latch and the sixth holding latch by an operation of the demux DM and the pixel data signal P7 stored at the seventh sampling latch may be stored to the seventh holding latch and the eighth holding latch by an operation of the demux DM.

Referring to FIGS. 11 and 12, when the resolution of the first display area DA1 is the quarter resolution, the corresponding pixel data signals P1, P5, P9 and P13 may be stored to the first sampling latch, the fifth sampling latch, the ninth sampling latch and the thirteenth sampling latch of the first driver DV1 at the rising edge of the first clock signal CLK1.

When the resolution of the first display area DA1 is the quarter resolution, the second clock signal CLK2, the third clock signal CLK3 and the fourth clock signal CLK4 may not have active pulses. In FIGS. 11 and 12, the second clock signal CLK2, the third clock signal CLK3 and the fourth clock signal CLK4 among the first to fourth clock signals CLK1 to CLK4 may not have the active pulses. The first clock signal CLK1 which has active pulses may have a cycle slower than a cycle of the first clock signal CLK1 of FIG. 5. Thus, a computational load and a power consumption of the display apparatus may be reduced.

As explained herein, when the resolution of the first display area DA1 is the quarter resolution, the pixel data signal P1 stored at the first sampling latch may be stored to the first holding latch, the second holding latch, the third holding latch and the fourth holding latch by an operation of the demux DM and the pixel data signal P5 stored at the fifth sampling latch may be stored to the fifth holding latch, the sixth holding latch, the seventh holding latch and the eighth holding latch by an operation of the demux DM.

According to the present embodiment, the data driver 500 may include the interface circuits IF1 to IF6 which independently operate with respect to one another and the drivers DV1 to DV6 which independently operate with respect to one another and are connected to the interface circuits IF1 to IF6 respectively and the display panel 100 may include the display areas DA1 to DA6 corresponding to the drivers DV1 to DV6 respectively.

The resolution of the display area corresponding to the user's viewing position EP may be set to be high and the resolution of the display area far from the user's viewing position EP may be set to be low so that the computational load and the power consumption of the display apparatus may be reduced without deteriorating a display quality.

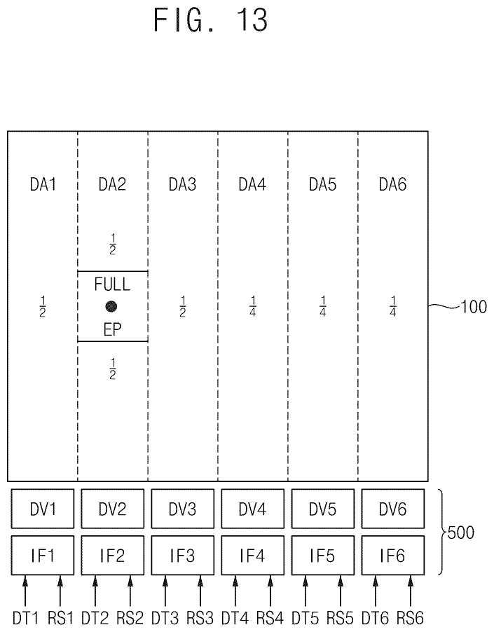

FIG. 13 is a diagram illustrating a display panel 100 and a data driver 500 according to an embodiment of the present disclosure.

The display apparatus according to the present embodiment is substantially the same as the display apparatus of the previous embodiment explained referring to FIGS. 1 to 4C and 7 to 12 except that the display panel not only has varied resolutions in the first direction but also has varied resolutions in the second direction. Thus, the same reference numerals will be used to refer to the same or like parts as those described in the previous embodiment of FIGS. 1 to 4C and 7 to 12 and any repetitive explanation concerning the above

### Elements Will Be Omitted.

Referring to FIG. 13, the display area (e.g., the second display area DA2) corresponding to the user's viewing position EP may have two or more resolutions (e.g., the half resolution, the full resolution and the half resolution) in the second direction D2.

For example, as a distance between a display position and the user's viewing position EP increases in the display area (e.g., the second display area DA2) corresponding to the user's viewing position EP, the resolution of the display position may decrease.

In FIG. 13, a resolution of the viewing position EP may be the full resolution and a resolution of a display position spaced apart from the viewing position EP by a predetermined distance in the second direction D2 may be the half resolution which is less than the full resolution.

The resolution signal RS1 to RS6 may have varied values in a unit of a horizontal line to vary the resolution in the second direction D2.

In contrast, when the resolution is not varied in the second direction D2, the resolution signal RS1 to RS6 may have varied values in a unit of a frame.

According to the present embodiment, the data driver 500 may include the interface circuits IF1 to IF6 which independently operate with respect to one another and the drivers DV1 to DV6 which independently operate with respect to one another and are connected to the interface circuits IF1 to IF6 respectively and the display panel 100 may include the display areas DA1 to DA6 corresponding to the drivers DV1 to DV6 respectively.

The resolution of the display area corresponding to the user's viewing position EP may be set to be high and the resolution of the display area far from the user's viewing position EP may be set to be low so that the computational load and the power consumption of the display apparatus may be reduced without deteriorating a display quality.

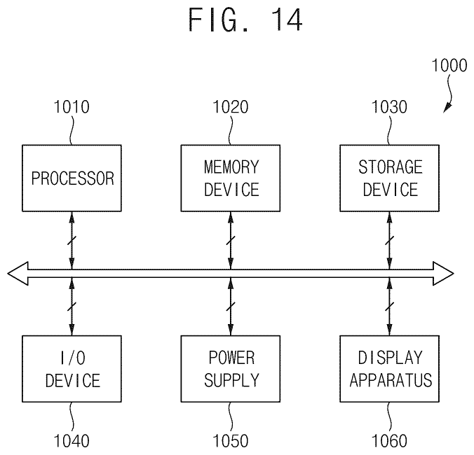

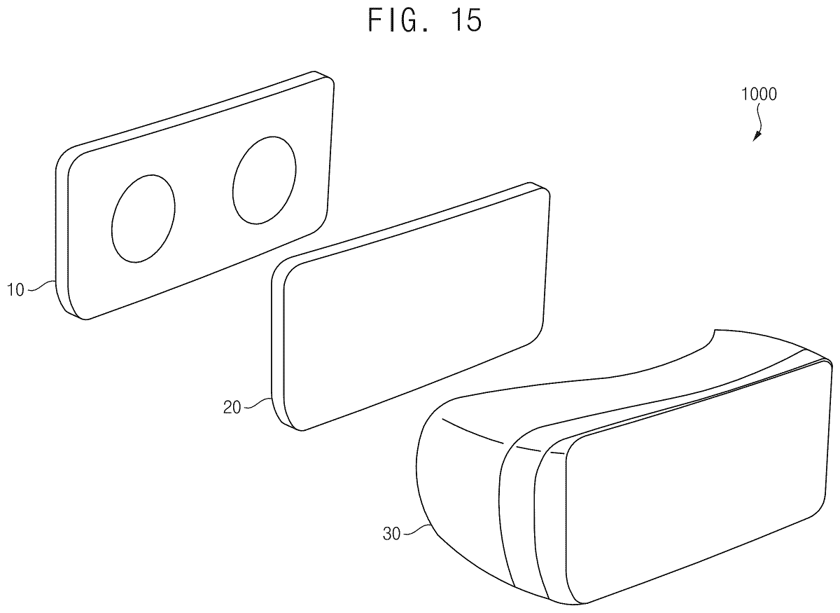

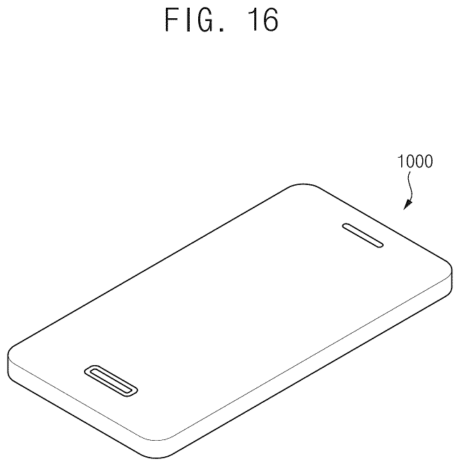

FIG. 14 is a block diagram illustrating an electronic apparatus 1000 according to an embodiment of the present disclosure. FIG. 15 is a diagram illustrating an example in which the electronic apparatus 1000 of FIG. 14 is implemented as a virtual reality display system. FIG. 16 is a diagram illustrating an example in which the electronic apparatus 1000 of FIG. 14 is implemented as a smart phone.

Referring to FIGS. 1 to 16, the electronic apparatus 1000 may include a processor 1010, a memory device 1020, a storage device 1030, an input/output (I/O) device 1040, a power supply 1050, and a display apparatus 1060. Here, the display apparatus 1060 may be the display apparatus of FIG. 1. In addition, the electronic apparatus 1000 may further include a plurality of ports for communicating with a video card, a sound card, a memory card, a universal serial bus (USB) device, other electronic apparatuses, or the like.

In an embodiment, as illustrated in FIG. 16, the electronic apparatus 1000 may be implemented as a smart phone. However, the electronic apparatus 1000 is not limited thereto. For example, the electronic apparatus 1000 may be implemented as a cellular phone, a video phone, a smart pad, a smart watch, a tablet PC, a car navigation system, a computer monitor, a laptop, a head mounted display (HMD) device, and the like.

The processor 1010 may perform various computing functions or various tasks. The processor 1010 may be a micro-processor, a central processing unit (CPU), an application processor (AP), and the like. The processor 1010 may be coupled to other components via an address bus, a control bus, a data bus, or the like. Further, the processor 1010 may be coupled to an extended bus such as a peripheral component interconnection (PCI) bus.

The processor 1010 may output the input image data IMG and the input control signal CONT to the driving controller 200 of FIG. 1.

The memory device 1020 may store data for operations of the electronic apparatus 1000. For example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, and the like and/or at least one volatile memory device such as a dynamic random access memory (DRAM) device, a static random access memory (SRAM) device, a mobile DRAM device, and the like.

The storage device 1030 may include a solid state drive (SSD) device, a hard disk drive (HDD) device, a CD-ROM device, and the like. The I/O device 1040 may include an input device such as a keyboard, a keypad, a mouse device, a touch-pad, a touch-screen, and the like and an output device such as a printer, a speaker, and the like. In some embodiments, the display apparatus 1060 may be included in the I/O device 1040. The power supply 1050 may provide power for operations of the electronic apparatus 1000. The display apparatus 1060 may be coupled to other components via the buses or other communication links.

Referring to FIG. 15, the virtual reality (VR) display system may include a lens 10, a display apparatus 20 and a housing 30. The display apparatus 20 may be disposed adjacent to the lens 10. The housing 30 may receive the lens 10 and the display apparatus 20. Although the lens 10 and the display apparatus 20 are received on a first side of the housing 30 in FIG. 15, the present disclosure may not be limited thereto. For example, the lens 10 may be received on a first side of the housing 30 and the display apparatus 20 may be received on a second side of the housing 30 opposite to the first side of the housing 30. When the lens 10 and the display apparatus 20 are received on opposite sides with respect to the housing 30, the housing 30 may have a transmitting portion to transmit a light.

For example, the VR display system may be a head mounted display system worn on a user's head. Although not shown in figures, the VR display system may further include a head band to fix the VR display system to the user's head.

Alternatively, the VR display system may have a form of smart glasses designed as a shape of glasses.

In addition, the electronic apparatus 1000 may be implemented as an augmented reality (AR) display system for supporting an augmented reality. The AR display system may have a smartphone shape, a smart glasses shape, a head mounted display shape, or the like, but may not be limited to those shapes.

In addition, the electronic apparatus 1000 may be implemented as a mixed reality (MR) display system for supporting a mixed reality. The MR display system may have a smartphone shape, a smart glasses shape, a head mounted display shape, or the like., but may not be limited to those shapes.

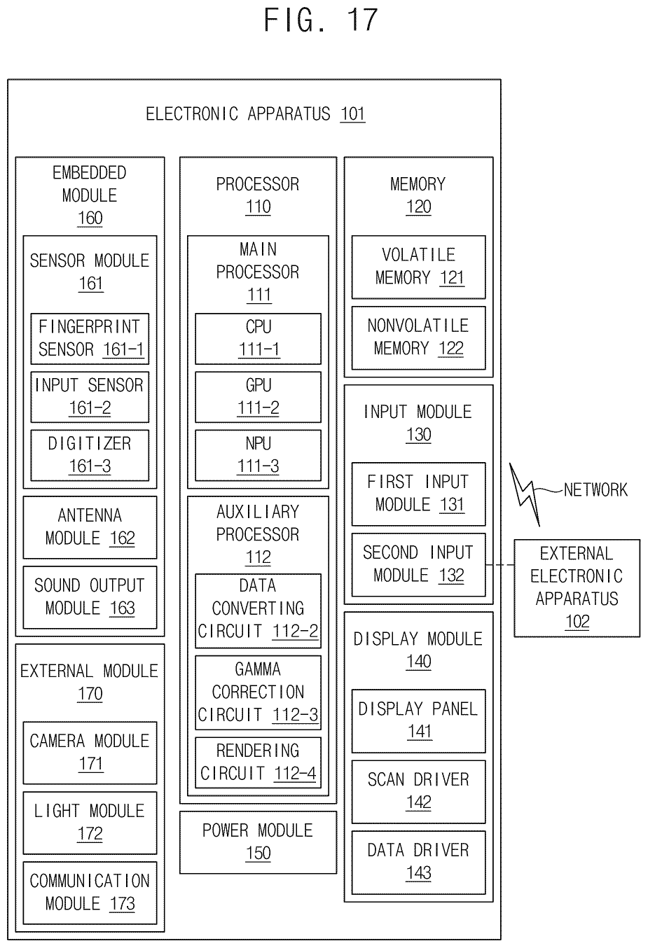

FIG. 17 is a block diagram illustrating an electronic apparatus 101 according to an embodiment of the present disclosure.

Referring to FIGS. 1 to 17, an electronic apparatus 101 outputs various information through a display module 140 in an operating system. When a processor 110 executes an application stored in a memory 120, the display module 140 provides application information to a user through a display panel 141.

The processor 110 obtains an external input through an input module 130 or a sensor module 161 and executes an application corresponding to the external input. For example, when the user selects a camera icon displayed on the display panel 141, the processor 110 obtains a user input through an input sensor 161-2 and activates a camera module 171. The processor 110 transfers image data corresponding to a captured image obtained through the camera module 171 to the display module 140. The display module 140 may display an image corresponding to the captured image through the display panel 141.

In an embodiment, when a personal information authentication is executed in the display module 140, a fingerprint sensor 161-1 obtains input fingerprint information as input data. The processor 110 compares input data obtained through the fingerprint sensor 161-1 with authentication data stored in the memory 120, and executes an application according to a comparison result. The display module 140 may display information executed according to application logic through the display panel 141.

In an embodiment, when a music streaming icon displayed on the display module 140 is selected, the processor 110 obtains a user input through the input sensor 161-2 and activates a music streaming application stored in the memory 120. When a music execution command is input in the music streaming application, the processor 110 activates a sound output module 163 to provide sound information corresponding to the music execution command to the user.

As described herein, the operation of the electronic apparatus 101 is briefly described. Hereinafter, a configuration of the electronic apparatus 101 is described in detail. Some of elements of the electronic apparatus 101 described later may be integrated and provided as one element, or one element may be separated as two or more elements.

The electronic apparatus 101 may communicate with an external electronic apparatus 102 through a network (e.g., a short-range wireless communication network or a long-range wireless communication network). According to an embodiment, the electronic apparatus 101 may include the processor 110, the memory 120, the input module 130, the display module 140, a power module 150, an embedded module 160, and an external module 170. According to an embodiment, in the electronic apparatus 101, at least one of the above-described elements may be omitted or one or more other apparatus may be added. According to an embodiment, some of the above-described elements (e.g., the sensor module 161, an antenna module 162 or the sound output module 163) may be integrated into another element (e.g., the display module 140).

The processor 110 may execute software to control at least one other element (e.g., hardware or software element) of the electronic apparatus 101 connected to the processor 110 and to perform various data processing or operations. According to an embodiment, as at least part of the data processing or the operations, the processor 110 may store receive instructions or data from other elements (e.g. the input module 130, the sensor module 161 or a communication module 173) in a volatile memory 121, may process the instructions or data stored in the volatile memory 121 and may store result data of the processing in a nonvolatile memory 122.

The processor 110 may include a main processor 111 and an auxiliary processor 112. The main processor 111 may include at least one of a central processing unit (CPU) 111-1 and an application processor (AP). The main processor 111 may further include any one or more of a graphic processing unit (GPU) 111-2, a communication processor (CP) and an image signal processor (ISP). The main processor 111 may further include a neural processing unit (NPU) 111-3. The neural network processing unit 111-3 is a processor specialized in processing an artificial intelligence model. The artificial intelligence model may be generated through a machine learning. The artificial intelligence model may include a plurality of artificial neural network layers. The artificial neural network may be one of a deep neural network (DNN), a convolutional neural network (CNN), a recurrent neural network (RNN), a restricted boltzmann machine (RBM), a deep belief network (DBN), a bidirectional recurrent deep neural network (BRDNN) and a deep Q-networks or a combination of two or more of the above. However, the artificial neural network is not limited to the above examples. The artificial intelligence model may include software structures, in addition to hardware structures or instead of the hardware structures. At least two of the above-described processing units and the above-described processors may be implemented as an integrated element (e.g., a single chip) or each may be implemented as independent elements (e.g., in a plurality of chips).

The auxiliary processor 112 may include a controller. The controller may include an interface conversion circuit and a timing control circuit. The controller receives an image signal from the main processor 111, converts a data format of the image signal to meet interface specifications with the display module 140, and outputs image data. The controller may output various control signals for driving the display module 140.

The auxiliary processor 112 may further include a data converting circuit 112-2, a gamma correction circuit 112-3 and a rendering circuit 112-4. The data converting circuit 112-2 may receive the image data from the controller and may compensate the image data such that the image is displayed with a desired luminance according to characteristics of the electronic apparatus 101 or a user setting or may convert the image data to reduce a power consumption or compensate for afterimages. The gamma correction circuit 112-3 may convert the image data or a gamma reference voltage such that the image displayed on the electronic apparatus 101 has desired gamma characteristics. The rendering circuit 112-4 may receive the image data from the controller and may render the image data based on a pixel arrangement of the display panel 141 included in the electronic apparatus 101. At least one of the data converting circuit 112-2, the gamma correction circuit 112-3 and the rendering circuit 112-4 may be integrated into another element (e.g., the main processor 111 or the controller). At least one of the data converting circuit 112-2, the gamma correction circuit 112-3 and the rendering circuit 112-4 may be integrated into a data driver 143 to be described later.

The memory 120 may store various data used by at least one element (e.g., the processor 110 or the sensor module 161) of the electronic apparatus 101 and input data or output data for commands related thereto. The memory 120 may include at least one of the volatile memory 121 and the nonvolatile memory 122.

The input module 130 may receive commands or data used to the elements (e.g., the processor 110, the sensor module 161 or the sound output module 163) of the electronic apparatus 101 from the outside of the electronic apparatus 101 (e.g., the user or the external electronic apparatus 102).

The input module 130 may include a first input module 131 for receiving commands or data from the user and a second input module 132 for receiving commands or data from the external electronic apparatus 102. The first input module 131 may include a microphone, a mouse, a keyboard, a key (e.g., a button) or a pen (e.g., a passive pen or an active pen). The second input module 132 may support a designated protocol capable of connecting to the external electronic apparatus 102 by wire or wirelessly. According to an embodiment, the second input module 132 may include a high definition multimedia interface (HDMI), a universal serial bus (USB) interface, an SD card interface or an audio interface. The second input module 132 may include a connector physically connected to the external electronic apparatus 102, for example, an HDMI connector, a USB connector, an SD card connector, or an audio connector (e.g., a headphone connector).

The display module 140 visually provides information to the user. The display module 140 may include the display panel 141, a scan driver 142 and the data driver 143. The display module 140 may further include a window, a chassis and a bracket to protect the display panel 141.

The display panel 141 may include a liquid crystal display panel, an organic light emitting display panel or an inorganic light emitting display panel. A type of the display panel 141 is not particularly limited. The display panel 141 may be a rigid type or a flexible type capable of being rolled or folded. The display module 140 may further include a supporter or a heat dissipation member supporting the display panel 141.

The scan driver 142 may be mounted on the display panel 141 as a driving chip. Alternatively, the scan driver 142 may be integrated on the display panel 141. For example, the scan driver 142 may include an amorphous silicon TFT gate driver circuit (ASG) integrated on the display panel 141, a low temperature polycrystalline silicon (LTPS) TFT gate driver circuit integrated on the display panel 141, or an oxide semiconductor TFT gate driver circuit (OSG) integrated on the display panel 141. The scan driver 142 receives a control signal from the controller and outputs the scan signals to the display panel 141 in response to the control signal.

The display module 140 may further include a light emission driver. The light emission driver outputs a light emission control signal to the display panel 141 in response to a control signal received from the controller. The light emission driver may be formed independently from the scan driver 142. Alternatively, the light emission driver and the scan driver 142 may be integrally formed.

The data driver 143 receives a control signal from the controller and converts the image data into an analog voltage (e.g., the data voltage) and output the data voltages to the display panel 141 in response to the control signal.

The data driver 143 may be integrated into another element (e.g. the controller). The functions of the interface conversion circuit and the timing control circuit of the controller described herein may be integrated into the data driver 143.

The display module 140 may further include a voltage generating circuit. The voltage generating circuit may output various voltages for driving the display panel 141.

The power module 150 supplies power to elements of the electronic apparatus 101. The power module 150 may include a battery which supplies a power voltage. The battery may include a non-rechargeable primary cell, a rechargeable secondary cell or a fuel cell. The power module 150 may include a power management integrated circuit (PMIC). The PMIC supplies optimized power to each of the above-described modules and modules described later. The power module 150 may include a wireless power transmission/reception member electrically connected to the battery. The wireless power transmission/reception member may include a plurality of antenna radiators in a form of coils.

The electronic apparatus 101 may further include the embedded module 160 and the external module 170. The embedded module 160 may include the sensor module 161, the antenna module 162 and the sound output module 163. The external module 170 may include the camera module 171, a light module 172 and the communication module 173.

The sensor module 161 may detect an input by a user's body or an input by the pen among the first input module 131, and generate an electrical signal or data value corresponding to the input. The sensor module 161 may include at least one of the fingerprint sensor 161-1, the input sensor 161-2 and a digitizer 161-3.

The fingerprint sensor 161-1 may generate a data value corresponding to a user's fingerprint. The fingerprint sensor 161-1 may include one of an optical fingerprint sensor or a capacitive fingerprint sensor.

The input sensor 161-2 may generate data values corresponding to coordinate information of the input by the user's body or the input by the pen. The input sensor 161-2 generates a capacitance change due to an input as a data value. The input sensor 161-2 may detect an input by the passive pen or transmit/receive data to/from the active pen.

The input sensor 161-2 may measure biosignals such as a blood pressure, a moisture, or a body fat. For example, when a user touches a part of his body to a sensor layer or a sensing panel and does not move for a certain period of time, the input sensor 161-2 may detect the biosignal based on a change in an electric field caused by the part of the body so that the display module 140 may output user's desired information.

The digitizer 161-3 may generate a data value corresponding to the coordinate information input by the pen. The digitizer 161-3 generates an amount of electromagnetic change by the input as a data value. The digitizer 161-3 may detect an input by the passive pen or transmit/receive data to/from the active pen.

At least one of the fingerprint sensor 161-1, the input sensor 161-2 and the digitizer 161-3 may be formed as a sensor layer on the display panel 141 through a continuous process. The fingerprint sensor 161-1, the input sensor 161-2 and the digitizer 161-3 may be disposed on the display panel 141. At least one of the fingerprint sensor 161-1, the input sensor 161-2 and the digitizer 161-3, for example, the digitizer 161-3, may be disposed under the display panel 141.

At least two or more of the fingerprint sensor 161-1, the input sensor 161-2 and the digitizer 161-3 may be integrated into the sensing panel through the same process. When at least two or more of the fingerprint sensor 161-1, the input sensor 161-2 and the digitizer 161-3 are integrated into the sensing panel, the sensing panel may be disposed between the display panel 141 and a window disposed over an upper surface of the display panel 141. According to an embodiment, the sensing panel may be disposed on the window. The present disclosure may not be limited to a position of the sensing panel.

At least one of the fingerprint sensor 161-1, the input sensor 161-2 and the digitizer 161-3 may be embedded in the display panel 141. For example, at least one of the fingerprint sensor 161-1, the input sensor 161-2 and the digitizer 161-3 is formed simultaneously with the display panel 141 through a process of forming elements included in the display panel 141 (e.g., light emitting elements, transistors, etc.).

In addition, the sensor module 161 may generate an electrical signal or a data value corresponding to an internal state or an external state of the electronic apparatus 101. For example, the sensor module 161 may further include a gesture sensor, a gyro sensor, a barometric pressure sensor, a magnetic sensor, an acceleration sensor, a grip sensor, a proximity sensor, a color sensor, an IR (infrared) sensor, a biosensor, a temperature sensor, a humidity sensor or an illuminance sensor.

The antenna module 162 may include one or more antennas for transmitting a signal or power to outside or receiving a signal or power from outside. According to an embodiment, the communication module 173 may transmit a signal to an external electronic apparatus or receive a signal from an external electronic apparatus through an antenna suitable for a communication method. An antenna pattern of the antenna module 162 may be integrated with an element of the display module 140 (e.g., the display panel 141) or the input sensor 161-2.

The sound output module 163 is a device for outputting sound signals to the outside of the electronic apparatus 101. For example, the sound output module 163 may include a speaker used for general purposes such as playing multimedia or recording and a receiver used exclusively for receiving a call. According to an embodiment, the receiver may be formed integrally with or separately from the speaker. A sound output pattern of the sound output module 163 may be integrated with the display module 140.

The camera module 171 may capture still images and moving images. According to an embodiment, the camera module 171 may include one or more lenses, an image sensor or an image signal processor. The camera module 171 may further include an infrared camera capable of determining a presence or an absence of a user, the user's location and the user's gaze.

The light module 172 may provide a light. The light module 172 may include a light emitting diode or a xenon lamp. The light module 172 may operate in conjunction with the camera module 171 or operate independently.

The communication module 173 may support establishment of a wired or wireless communication channel between the electronic apparatus 101 and the external electronic apparatus 102 and communication through the established communication channel. The communication module 173 may include one or both of a wireless communication module such as a cellular communication module, a short-distance wireless communication module, or a global navigation satellite system (GNSS) communication module and a wired communication module such as a local area network (LAN) communication module, or a power line communication module. The communication module 173 may communicate with the external electronic apparatus 102 through a short-range communication network such as Bluetooth, WiFi direct or infrared data association (IrDA) or a long-distance communication network such as a cellular network, the Internet, or a computer network (e.g., LAN or WAN). The various types of communication modules 173 described herein may be implemented as a single chip or may be implemented as separate chips.

The input module 130, the sensor module 161 and the camera module 171 may be used to control the operation of the display module 140 in conjunction with the processor 110.

The processor 110 outputs commands or data to the display module 140, the sound output module 163, the camera module 171 or the light module 172 based on the input data received from the input module 130. For example, the processor 110 may generate image data corresponding to input data applied through a mouse or an active pen, and output the generated image data to the display module 140 or the processor 110 may generate command data corresponding to the input data and output the generated command data to the camera module 171 or the light module 172. When input data is not received from the input module 130 for a certain period of time, the processor 110 converts an operation mode of the electronic apparatus 101 into a low power mode or a sleep mode so that a power consumption of the electronic apparatus 101 may be reduced.

The processor 110 outputs commands or data to the display module 140, the sound output module 163, the camera module 171 or the light module 172 based on sensed data received from the sensor module 161. For example, the processor 110 may compare authentication data applied by the fingerprint sensor 161-1 with authentication data stored in the memory 120, and then execute an application according to the comparison result. The processor 110 may execute commands or output corresponding image data to the display module 140 based on the sensed data sensed by the input sensor 161-2 or the digitizer 161-3. When the sensor module 161 includes a temperature sensor, the processor 110 may receive temperature data for the temperature measured from the sensor module 161 and may further perform luminance correction on the image data based on the temperature data.

The processor 110 may receive determined data about the presence or the absence of the user, the user's location and the user's gaze from the camera module 171. The processor 110 may further perform luminance correction on the image data based on the determined data. For example, the processor 110, which determines the presence or the absence of the user through an input from the camera module 171, may display image data having the luminance corrected by the data converting circuit 112-2 or the gamma correction circuit 112-3 to the display module 140.

Some of the elements described herein may be connected to each other through a communication method between peripheral devices such as a bus, a general purpose input/output (GPIO), a serial peripheral interface (SPI), a mobile industry processor interface (MIPI), or a ultra path interconnect (UPI) link to exchange signals (e.g., commands or data) with each other. The processor 110 may communicate with the display module 140 through an agreed interface. For example, the processor 110 may communicate with the display module 140 through any one of the communication methods described herein. Embodiment of the present disclosure may not be limited to the above communication methods.

The electronic apparatus 101 according to various embodiments disclosed in the disclosure may be various types of apparatuses. For example, the electronic apparatus 101 may include at least one of a monitor, a portable communication apparatus (e.g., a smart phone), a computer apparatus, a portable multimedia apparatus, a portable medical apparatus, a camera, a wearable device and a home appliance. The electronic apparatus 101 according to the embodiment of the disclosure may not be limited to the aforementioned apparatuses.

For example, the display panel 100 of FIG. 1 may correspond to the display panel 141 of FIG. 17. For example, the driving controller 200 of FIG. 1 may correspond to the controller of the auxiliary processor 112 of FIG. 17. For example, the gate driver 300 of FIG. 1 may correspond to the scan driver 142 of FIG. 17. For example, the data driver 500 of FIG. 1 may correspond to the data driver 143 of FIG. 17.

According to the display apparatus, the method of driving the display apparatus and the electronic apparatus including the display apparatus of the present disclosure as explained herein, the computational load and the power consumption of the display apparatus may be reduced.

The foregoing is illustrative of the present disclosure and is not to be construed as limiting thereof. Although a few embodiments of the present disclosure have been described, those skilled in the art will readily appreciate that many modifications are possible in the embodiments without materially departing from the novel teachings and advantages of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific embodiments disclosed, and that modifications to the disclosed embodiments, as well as other embodiments, are intended to be included within the scope of the appended claims. The present disclosure is defined by the following claims, with equivalents of the claims to be included therein.

What is claimed is:

1. A display apparatus comprising:
a display panel;
a data driver in signal communication with the display panel, the data driver configured to output a data voltage to the display panel;
a driving controller in signal communication with the data driver, the driving controller configured to control an operation of the data driver; and
an eye tracker in signal communication with the driving controller, the eye tracker configured to output a view signal representing a user's viewing position to the driving controller,
wherein the data driver comprises:
a plurality of interface circuits configured to independently operate; and
a plurality of drivers configured to independently operate, the plurality of drivers being connected one-to-one to the interface circuits,
wherein the display panel comprises a plurality of display areas corresponding one-to-one to the drivers, and
wherein a resolution of a display area corresponding to the user's viewing position is different from a resolution of a display area not corresponding to the user's viewing position.

2. The display apparatus of claim 1, wherein the resolution of the display area decreases as a distance between the display area and the user's viewing position increases,.

3. The display apparatus of claim 1, wherein the interface circuit is configured to receive a data signal corresponding to the interface circuit and a resolution signal corresponding to the interface circuit.

4. The display apparatus of claim 3, wherein the driver comprises:
a shift register configured to receive a horizontal synchronization signal and a clock signal;
a sampling latch connected to the shift register, the sampling latch configured to receive the data signal;
a demultiplexer (demux) connected to the sampling latch, the demux configured to receive the resolution signal;
a holding latch connected to the sampling latch through the demux;
a digital to analog converter connected to the holding latch; and
an amplifier connected to the digital to analog converter.

5. The display apparatus of claim 1, wherein when a resolution of a first display area is a full resolution:
a first sampling latch of a first driver is configured to store a first pixel data signal;
a second sampling latch of the first driver is configured to store a second pixel data signal;
a third sampling latch of the first driver is configured to store a third pixel data signal;
a fourth sampling latch of the first driver is configured to store a fourth pixel data signal;
a fifth sampling latch of the first driver is configured to store a fifth pixel data signal;
a sixth sampling latch of the first driver is configured to store a sixth pixel data signal;
a seventh sampling latch of the first driver is configured to store a seventh pixel data signal;
an eighth sampling latch of the first driver is configured to store an eighth pixel data signal;
a first holding latch of the first driver connected to the first sampling latch is configured to store the first pixel data signal;
a second holding latch of the first driver connected to the second sampling latch is configured to store the second pixel data signal;
a third holding latch of the first driver connected to the third sampling latch is configured to store the third pixel data signal;
a fourth holding latch of the first driver connected to the fourth sampling latch is configured to store the fourth pixel data signal;
a fifth holding latch of the first driver connected to the fifth sampling latch is configured to store the fifth pixel data signal;
a sixth holding latch of the first driver connected to the sixth sampling latch is configured to store the sixth pixel data signal;
a seventh holding latch of the first driver connected to the seventh sampling latch is configured to store the seventh pixel data signal; and
an eighth holding latch of the first driver connected to the eighth sampling latch is configured to store the eighth pixel data signal.

6. The display apparatus of claim 5, wherein when the resolution of the first display area is the full resolution, a demultiplexer (demux) of the first driver, in response to receiving a first resolution signal, is configured to:
connect the first sampling latch to the first holding latch;
connect the second sampling latch to the second holding latch;
connect the third sampling latch to the third holding latch;
connect the fourth sampling latch to the fourth holding latch;
connect the fifth sampling latch to the fifth holding latch;
connect the sixth sampling latch to the sixth holding latch;
connect the seventh sampling latch to the seventh holding latch; and
connect the eighth sampling latch to the eighth holding latch.

7. The display apparatus of claim 1, wherein when a resolution of a first display area is a half resolution:
a first sampling latch of a first driver is configured to store a first pixel data signal;
a third sampling latch of the first driver is configured to store a third pixel data signal;
a fifth sampling latch of the first driver is configured to store a fifth pixel data signal;
a seventh sampling latch of the first driver is configured to store a seventh pixel data signal;
a first holding latch of the first driver connected to the first sampling latch is configured to store the first pixel data signal;
a second holding latch of the first driver connected to the first sampling latch is configured to store the first pixel data signal;
a third holding latch of the first driver connected to the third sampling latch is configured to store the third pixel data signal;
a fourth holding latch of the first driver connected to the third sampling latch is configured to store the third pixel data signal;
a fifth holding latch of the first driver connected to the fifth sampling latch is configured to store the fifth pixel data signal;
a sixth holding latch of the first driver connected to the fifth sampling latch is configured to store the fifth pixel data signal;
a seventh holding latch of the first driver connected to the seventh sampling latch is configured to store the seventh pixel data signal; and
an eighth holding latch of the first driver connected to the seventh sampling latch is configured to store the seventh pixel data signal.

8. The display apparatus of claim 7, wherein when the resolution of the first display area is the half resolution, a demultiplexer (demux) of the first driver, in response to a first resolution signal, is configured to:
connect the first sampling latch to the first holding latch and the second holding latch;
connect the third sampling latch to the third holding latch and the fourth holding latch;
connect the fifth sampling latch to the fifth holding latch and the sixth holding latch; and
connect the seventh sampling latch to the seventh holding latch and the eighth holding latch.

9. The display apparatus of claim 7, wherein when the resolution of the first display area is the half resolution, each of a second sampling latch, a fourth sampling latch, a sixth sampling latch, and an eighth sampling latch is configured not to store a pixel data signal.

10. The display apparatus of claim 1, wherein when a resolution of a first display area is a quarter resolution:
a first sampling latch of a first driver is configured to store a first pixel data signal;
a fifth sampling latch of the first driver is configured to store a fifth pixel data signal;
a first holding latch of the first driver connected to the first sampling latch is configured to store the first pixel data signal;
a second holding latch of the first driver connected to the first sampling latch is configured to store the first pixel data signal;
a third holding latch of the first driver connected to the first sampling latch is configured to store the first pixel data signal;
a fourth holding latch of the first driver connected to the first sampling latch is configured to store the first pixel data signal;
a fifth holding latch of the first driver connected to the fifth sampling latch is configured to store the fifth pixel data signal;
a sixth holding latch of the first driver connected to the fifth sampling latch is configured to store the fifth pixel data signal;
a seventh holding latch of the first driver connected to the fifth sampling latch is configured to store the fifth pixel data signal; and
an eighth holding latch of the first driver connected to the fifth sampling latch is configured to store the fifth pixel data signal.

11. The display apparatus of claim 10, wherein when the resolution of the first display area is the quarter resolution, a demultiplexer (demux) of the first driver, in response to a first resolution signal, is configured to:
connect the first sampling latch to the first holding latch, the second holding latch, the third holding latch, and the fourth holding latch; and
connect the fifth sampling latch to the fifth holding latch, the sixth holding latch, the seventh holding latch, and the eighth holding latch.

12. The display apparatus of claim 10, wherein when the resolution of the first display area is the quarter resolution, each of a second sampling latch, a third sampling latch, a fourth sampling latch, a sixth sampling latch, a seventh sampling latch, and an eighth sampling latch is configured not to store a pixel data signal.

13. The display apparatus of claim 1, wherein when a resolution of a first display area is a full resolution:
corresponding pixel data signals are stored to each of a first sampling latch, a fifth sampling latch, a ninth sampling latch, and a thirteenth sampling latch of a first driver at a rising edge of a first clock signal;
corresponding pixel data signals are stored to each of a second sampling latch, a sixth sampling latch, a tenth sampling latch, and a fourteenth sampling latch of the first driver at a rising edge of a second clock signal;
corresponding pixel data signals are stored to each of a third sampling latch, a seventh sampling latch, an eleventh sampling latch, and a fifteenth sampling latch of the first driver at a rising edge of a third clock signal; and
corresponding pixel data signals are stored to each of a fourth sampling latch, an eighth sampling latch, a twelfth sampling latch, and a sixteenth sampling latch of the first driver at a rising edge of a fourth clock signal.

14. The display apparatus of claim 1, wherein when a resolution of a first display area is a half resolution:
corresponding pixel data signals are stored to each of a first sampling latch, a fifth sampling latch, a ninth sampling latch, and a thirteenth sampling latch of a first driver at a rising edge of a first clock signal;
corresponding pixel data signals are stored to each of a third sampling latch, a seventh sampling latch, an eleventh sampling latch, and a fifteenth sampling latch of the first driver at a rising edge of a third clock signal; and
a second clock signal and a fourth clock signal do not have active pulses.

15. The display apparatus of claim 1, wherein when a resolution of a first display area is a quarter resolution:
corresponding pixel data signals are stored to each of a first sampling latch, a fifth sampling latch, a ninth sampling latch, and a thirteenth sampling latch of a first driver at a rising edge of a first clock signal; and
a second clock signal, a third clock signal, and a fourth clock signal do not have active pulses.

16. The display apparatus of claim 1, wherein the display areas are disposed adjacent to each other in a first direction, and
wherein the display area corresponding to the user's viewing position has two or more resolutions in a second direction different from the first direction.

17. The display apparatus of claim 16, wherein a resolution of the display position decreases as a distance between a display position and the user's viewing position increases in the display area corresponding to the user's viewing position.

18. A method of driving a display apparatus, the method comprising:
determining a user's viewing position; and
driving a display area corresponding to the user's viewing position at a first resolution and driving a display area not corresponding to the user's viewing position at a second resolution different from the first resolution,
wherein driving the display area corresponding to the user's viewing position and the display area not corresponding to the user's viewing position includes using a plurality of interface circuits configured to independently operate and a plurality of drivers configured to independently operate, and
wherein the drivers are connected one-to-one to the interface circuits.

19. An electronic apparatus comprising:
a display panel;
a data driver in signal communication with the display panel, the data driver configured to output a data voltage to the display panel;
a driving controller in signal communication with the data driver, the driving controller configured to control an operation of the data driver;
an eye tracker in signal communication with the driving controller, the eye tracker configured to output a view signal representing a user's viewing position to the driving controller; and
a processor in signal communication with the driving controller, the processor configured to output each of input image data and an input control signal to the driving controller,
wherein the data driver comprises:
a plurality of interface circuits configured to independently operate; and
a plurality of drivers configured to independently operate, the plurality of drivers being connected one-to-one to the interface circuits,
wherein the display panel comprises a plurality of display areas corresponding one-to-one to the plurality of drivers, and
wherein a resolution of a display area corresponding to the user's viewing position is different from a resolution of a display area not corresponding to the user's viewing position.

20. The electronic apparatus of claim 19, wherein the input image data includes color data associated with one or more pixels of the display panel.
